(19) United States
(12) Patent Application Publication
(10) Pub. No.: US 2009/0277059 A1
(43) Pub. Date: Nov. 12, 2009

(54) Bi-color Illuminated Emblem

(76) Inventor: Young Chul Kwon, Granada Hills, CA (US)

Correspondence Address: PARK LAW FIRM, 3255 WILSHIRE BLVD, SUITE 1110, LOS ANGELES, CA, 90010, US

(21) Appl. No.: 12/263,353

(22) Filed: Oct. 31, 2008

Related U.S. Application Data
(63) Continuation-in-part of application No. 12/059,134, filed on Mar. 31, 2008, now abandoned.

(51) Int. Cl. G09F 13/04; F28F 3/00

(52) U.S. Cl. 40/581; 165/185

(57) ABSTRACT

A bi-color illuminated emblem includes a metal-look portion having a metal look layer, a substrate layer that supports the metal look layer, and a plurality of illuminating elements. The metal look layer and the substrate layer pass light from the illuminating elements. The illuminating elements emit light within a predetermined emission angle, which is 120 degree. The substrate layer is made of semi-transparent ABS. The substrate layer comprises an outer surface which supports the metal look layer, and an inner surface that faces the illuminating elements and has coarse texture that causes scattering of light. The distance between the inner surface of the substrate layer and the illuminating elements is in a range from 7˜10 mm. The illuminating element comprises an LED and a light guiding element that guides the light from the LED emits throughout and within the predetermined angle.

### CROSS REFERENCE TO RELATED APPLICATIONS

This application is a continuation-in-part application of U.S. patent application Ser. No. 12/059,134, filed by the applicant on Mar. 31, 2008, the disclosure of which is incorporated by reference as if fully set forth herein.

### BACKGROUND OF THE INVENTION

This invention is related to an illuminated emblem. More particularly, the invention is related to an illuminated emblem that has a first look as a non-illuminated ordinary emblem in day time, and a second look as an illuminated emblem in night time. The first look and the second look have different colors.

Many emblems for automotive use have hybrid look including colored part and shiny part. In the night time, backlighting effect may be added to the emblem for increased decoration effect and functioning as an indicator may be provided by the backlighting effect.

Emblems by prior art did not provide the combination of integrated and natural look that differs in day and night time, and sufficient brightness of backlighting suitable for automotive use.

### SUMMARY OF THE INVENTION

The present invention contrives to solve the disadvantages of the prior art.

An objective of the invention is to provide a bi-color illuminated emblem that integrates typical day time look of an automotive emblem with back lighted night time look of an automotive part.

Another objective of the invention is to provide a bi-color illuminated emblem that can provide uniform and sufficiently bright illuminated portion.

Still another objective of the invention is to provide a bi-color illuminate emblem that do not accumulate heat and removes heat promptly.

In order to achieve the above objective, the present invention provides a bi-color illuminated emblem that includes a metal-look portion having a metal look layer, a substrate layer that supports the metal look layer, and a plurality of illuminating elements.

The illuminating elements are arranged to conform to the shape of the metal-look portion. The metal look layer and the substrate layer pass light from the illuminating elements. The illuminating elements emit light within a predetermined emission angle.

Preferably, the predetermined emission angle is within a range from about 110 degree to about 130 degree. More preferably, the predetermined emission angle is about 120 degree.

The substrate layer is made of semi-transparent ABS.

The substrate layer comprises an outer surface which supports the metal look layer, and an inner surface that faces the illuminating elements and has coarse texture that causes scattering of light.

Preferably, the distance between the inner surface of the substrate layer and the illuminating elements is in a range from 5˜12 mm. More preferably, the distance between the inner surface of the substrate layer and the illuminating elements is in a range from 7˜10 mm.

The illuminating element comprises an LED and a light guiding element that guides the light from the LED emits throughout and within the predetermined angle.

The bi-color illuminated emblem further includes a cooling device for cooling the illuminating elements. The cooling device includes a heat conducting plate that is connected to the illuminating elements.

The bi-color illuminated emblem further includes a non-metal look colored portion that is adjacent to the metal-look portion.

The metal look layer comprises a metal coated sheet. Alternatively, the metal look layer is vacuum evaporation coated on the substrate layer.

The bi-color illuminated emblem further includes a clear coating on top of the metal look layer.

The bi-color illuminated emblem further includes a light diffusion layer that diffuses light from the illuminating elements. The light diffusion layer comprises a plurality of tooth elements that are adapted to refract light from the illuminating elements in various directions.

The substrate layer and the light diffusion area may be integrated.

The illuminated emblem serves purposes of decoration and security warning. The illuminated emblem of the present invention provides the same look and satisfies design requirement of emblem for major automotive companies. That is, the emblem has shiny metal and brilliant color look.

The illuminated emblem further provides outstanding decoration effect at dark environment by emitting bright and colored light. The emblem also provides warning effect such as stop signal or turn signal. The emblem provides bright enough directional light required for warning effect in driving situations.

The emblem can be provided in many different shape and structure. The outer surface of the emblem may be flat or include convex and concave portions.

The emblem provides a uniformly illuminated look while the illuminating elements are discrete due to the scattering effect of the substrate layer and illuminating elements construction.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an elevation view showing an emblem having letters and an oval edge strip, and colored part between the letters and the oval edge strip;

FIG. 2 is an elevation view showing an emblem having a polygonal shape and an edge strip that surrounds the polygon;

FIG. 3 is an elevation view showing an emblem including a symbol that has an arbitrary shape and an edge strip that surrounds the symbol, and colored portions inside the symbol and outside the symbol;

FIGS. 4, 5 and 6 are elevation views showing a plurality of illuminating elements that are arranged along the geometrical contour of the illuminated part of the emblems shown in FIGS. 1, 2 and 3;

FIG. 7 is a cross-sectional view taken along line VII-VII on FIG. 5;

FIG. 8 is a plan view of a bi-color illuminated emblem of a second embodiment;

FIG. 9 is a plan view of a base with illuminating elements;

FIG. 10 is a cross-sectional view taken along line X-X in FIG. 8;

FIG. 11 is a plan view of the illuminating element;

FIG. 12 is a cross-sectional view of the illuminating element; and

FIG. 13 is an enlarged cross-sectional view of the emblem.

### DETAILED DESCRIPTION OF THE INVENTION

FIG. 1 shows an emblem 10 that has letters 12 and an oval edge strip 14, and colored part 16 between the letters 12 and the oval edge strip 14. The letters 12 and the oval edge strip 14 have metal look, and the colored part 16 has a color that has a strong contrast with the metal look part, including blue and black. In night time, the letters 12 are illuminated from behind and show red color. The letters 12 are used to represent manufacturer or a model name of a car.

FIG. 2 shows another emblem 18 that has a polygonal center portion 20 and an edge strip 22 that surrounds the polygonal center portion 20. Both of the polygonal center portion 20 and the edge strip 22 have metal look but have different colors. In night time, the polygonal center portion 20 is illuminated from behind and shows a third color, including red. The polygon-shaped emblem 18 is used to represent a logo of an automotive manufacturer.

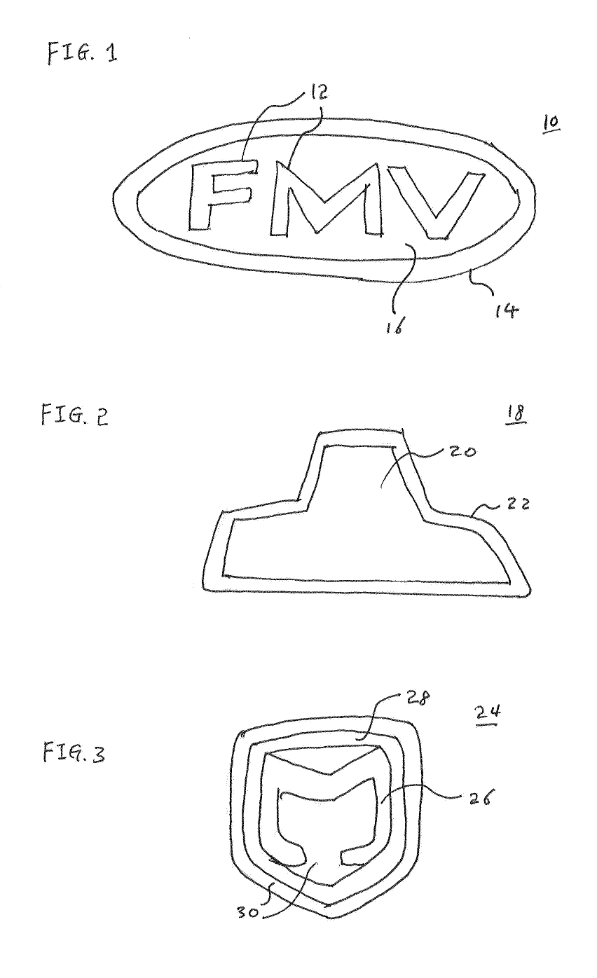

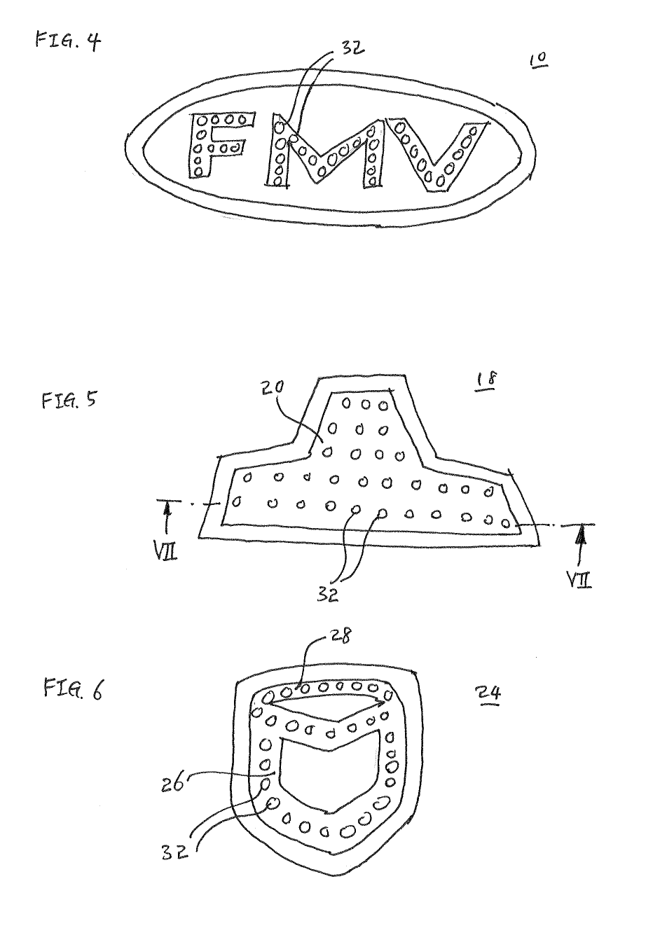

FIG. 3 shows still another emblem 24 that includes a symbol 26 that may be an arbitrary shape and an edge strip 28 that surrounds the symbol 26, and colored portions 30 inside the symbol 26 and outside the symbol 26. The symbol 26 and the edge strip 28 have metal look, and are illuminated from behind during night time. The symbol 26 is used to represent manufacturer's symbol that has not a regular geometrical shape.

FIG. 4 shows that a plurality of illuminating elements 32 are arranged along the geometrical contour of the letters 12.

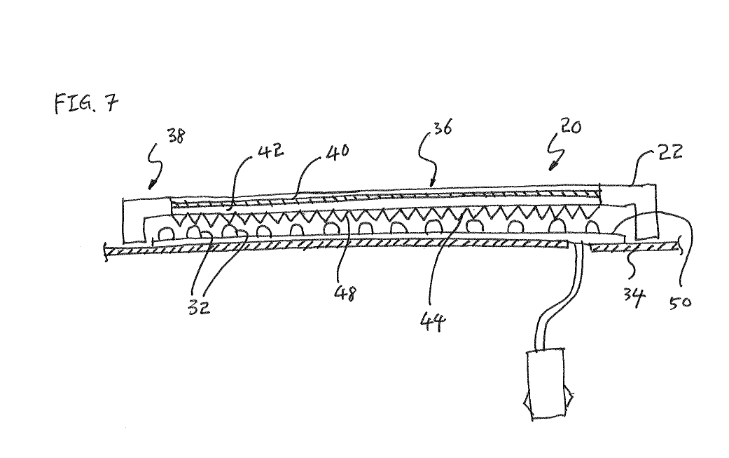

FIG. 5 shows that a plurality of illuminating elements 32 are arranged along the geometrical contour of the polygonal center portion 20.

FIG. 6 shows that a plurality of illuminating elements 32 are arranged along the geometrical contour of the symbol 26 and the edge strip 28.

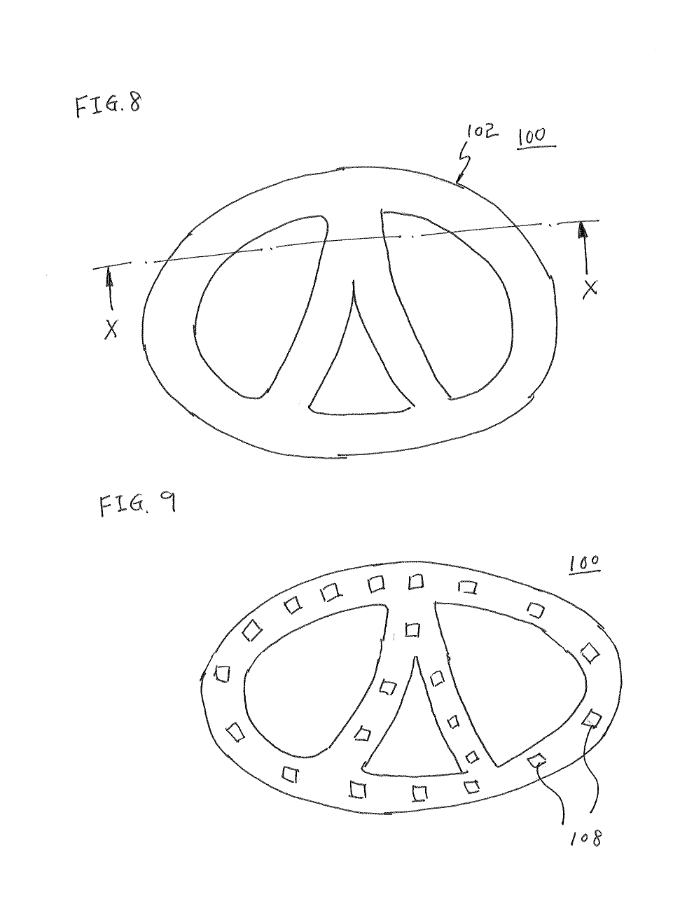

FIG. 7 shows that the bi-color illuminated emblem 18, which is attached on a body panel 14 of an automobile, includes a metal-look portion 36 and a non-metal look colored portion 38 that is adjacent to the metal-look portion 36.

The metal-look portion 36 includes a metal look layer 40, a substrate layer 42 that supports the metal look layer 40, a plurality of the illuminating elements 32 and a light diffusion layer 44 that diffuses light from the illuminating elements 32.

The substrate layer 42 provides a medium on which the metal look layer 40 is firmly attached. Alternatively, the substrate layer 42, itself may be used for bi-color display without the metal look layer 40. A plastic sheet having a commercial name ‘Superglas Dulight’ may be used as the substrate layer 42. The property of Dulight is well explained in Korean Patent No. 10-0596325, the disclosure of which is incorporated by reference. The substrate layer has a property that changes color when it is illuminated. The substrate layer provides bright and directional light when it is illuminated, which is required for warning light for stop or turn signal.

The illuminating elements 32 are arranged to conform to the shape of the metal-look portion 36. The metal look layer 40 and the substrate layer 42 pass light from the illuminating elements 32.

The metal look layer 40 is provided as a metal coated sheet, or is vacuum evaporation coated on the substrate layer 42. The metal coating is made in a density that allows back illuminating. A sheet that is commonly called ‘solar paper’ may be used as the metal look layer 40.

The bi-color illuminated emblem further includes a clear coating 46 on top of the metal look layer 42. The clear coating is provided for protection and for more realistic look. The clear coating renders the multi-layer structure of the emblem like a sold metal emblem. The clear coating is made of epoxy.

The light diffusion layer 44 includes a plurality of tooth elements 48 that are adapted to refract light from the illuminating elements 32 to various directions. The substrate layer 42 and the light diffusion area 44 are integrated and is molded of clear polycarbonate.

The bi-color illuminated emblem further includes a base 50 on which the illuminating elements 32 are attached, and the illuminating element comprises an LED. For the illuminating element 32, an LED is used for satisfying durability, brightness, and color requirement of the emblem.

FIGS. 8, 10 and FIG. 13 show a bi-color illuminated emblem 100 that includes a metal-look portion 102 having a metal look layer 104, a substrate layer 106 that supports the metal look layer 104, and a plurality of illuminating elements 106.

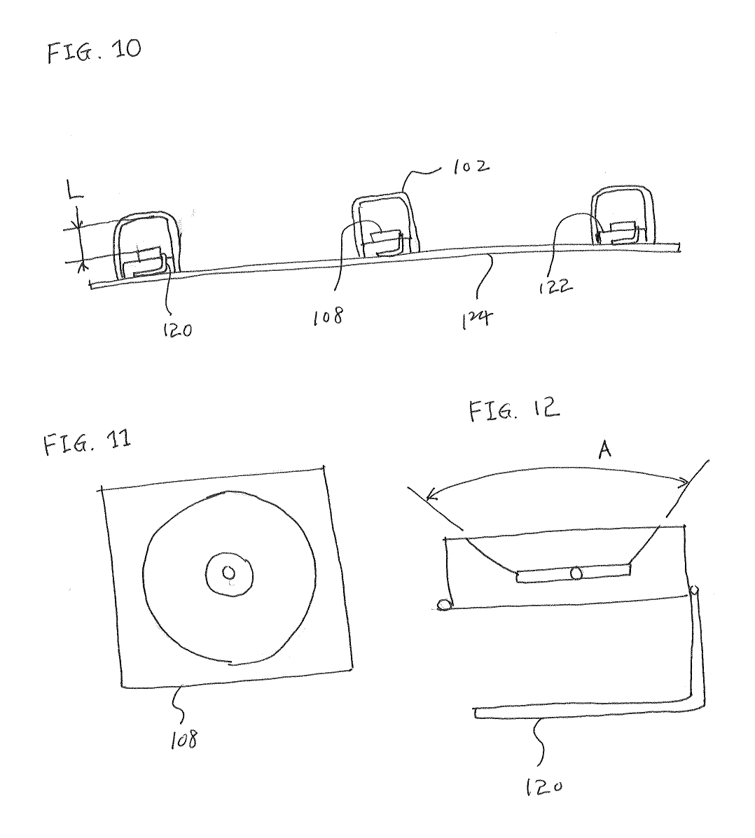

FIG. 9 shows that the illuminating elements 106 are arranged to conform to the shape of the metal-look portion 102. The metal look layer 104 and the substrate layer 106 pass light from the illuminating elements 108. The illuminating elements 108 emit light within a predetermined emission angle A (refer to FIG. 12).

Preferably, the predetermined emission angle A is within a range from about 110 degree to about 130 degree. More preferably, the predetermined emission angle is about 120 degree. This wide emission of light helps to provide a more uniform illumination.

The substrate layer 106 is made of semi-transparent ABS, or natural ABS. The property of semi-transparency is better than clear ABS in making the appearance of the illuminated emblem more uniform.

The substrate layer 106 comprises an outer surface 110 which supports the metal look layer 104, and an inner surface 112 that faces the illuminating elements 108 and has coarse texture that causes scattering of light, thus providing more uniform appearance. The coarse texture can be provided by grainy surface of a mold or by scratching the inner surface.

Preferably, the distance L between the inner surface 112 of the substrate layer 106 and the illuminating elements 108 is in a range from 5˜12 mm. More preferably, the distance L is in a range from 7˜10 mm. The distance provides space for scattering and dispersing light from the illuminating element. The illuminating element has a very low profile and that helps to provide more space inside the emblem.

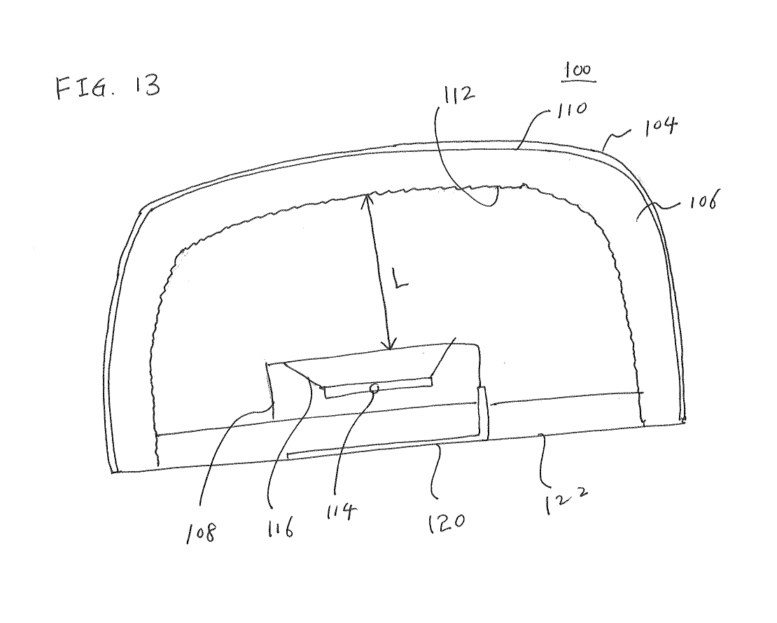

FIGS. 11 and 12 shows that the illuminating element 108 comprises an LED 114 and a light guiding element 116 that guides the light from the LED 114 emits throughout and within the predetermined angle A.

The bi-color illuminated emblem 100 further includes a cooling device 118 for cooling the illuminating elements. The cooling device 118 includes a heat conducting plate 120 that is connected to the illuminating elements 108, and attached to a base 122 that supports the illuminating elements and is attached to a body panel 124 of an automobile. The heat conducting plate 120 removes heat from the LED and transfers the heat to the body panel 124 thereby preventing overheating of the emblem.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A bi-color illuminated emblem comprising:
a metal-look portion that comprises:
a) a metal look layer;
b) a substrate layer that supports the metal look layer; and
c) a plurality of illuminating elements;
wherein the illuminating elements are arranged to conform to the shape of the metal-look portion, wherein the metal look layer and the substrate layer pass light from the illuminating elements, wherein the illuminating elements emit light within a predetermined emission angle.

2. The bi-color illuminated emblem of claim 1, wherein the predetermined emission angle is within a range from about 110 degree to about 130 degree.

3. The bi-color illuminated emblem of claim 2, wherein the predetermined emission angle is about 120 degree.

4. The bi-color illuminated emblem of claim 2, wherein the substrate layer is made of semi-transparent ABS.

5. The bi-color illuminated emblem of claim 4, wherein the substrate layer comprises an outer surface which supports the metal look layer, and an inner surface that faces the illuminating elements, wherein the inner surface has coarse texture that causes scattering of light.

6. The bi-color illuminated emblem of claim 5, wherein the distance between the inner surface of the substrate layer and the illuminating elements is in a range from 5˜12 mm.

7. The bi-color illuminated emblem of claim 6, wherein the distance between the inner surface of the substrate layer and the illuminating elements is in a range from 7˜10 mm.

8. The bi-color illuminated emblem of claim 7, wherein the illuminating element comprises an LED and a light guiding element that guides the light from the LED emits throughout and within the predetermined angle.

9. The bi-color illuminated emblem of claim 8, further comprising a cooling device for cooling the illuminating elements.

10. The bi-color illuminated emblem of claim 9, wherein the cooling device comprises a heat conducting plate that is connected to the illuminating elements.

11. The bi-color illuminated emblem of claim 8, further comprising a non-metal look colored portion that is adjacent to the metal-look portion.

12. The bi-color illuminated emblem of claim 8, wherein the metal look layer comprises a metal coated sheet.

13. The bi-color illuminated emblem of claim 12, further comprising a clear coating on top of the metal look layer.

14. The bi-color illuminated emblem of claim 12, further comprising a light diffusion layer that diffuses light from the illuminating elements, wherein the light diffusion layer comprises a plurality of tooth elements that are adapted to refract light from the illuminating elements in various directions.

15. The bi-color illuminated emblem of claim 14, wherein the substrate layer and the light diffusion area are integrated.

16. The bi-color illuminated emblem of claim 14, further comprising a base on which the illuminating elements are attached.

17. The bi-color illuminated emblem of claim 8, wherein the metal look layer is vacuum evaporation coated on the substrate layer.

18. The bi-color illuminated emblem of claim 17, further comprising a clear coating on top of the metal look layer.

19. The bi-color illuminated emblem of claim 18, further comprising a light diffusion layer that diffuses light from the illuminating elements wherein the light diffusion layer comprises a plurality of tooth elements that are adapted to refract light from the illuminating elements to various directions.
